(19) United States
(12) Patent Application Publication
(10) Pub. No.: US 2022/0011136 A1
(43) Pub. Date: Jan. 13, 2022

(54) ROAD DATA PROCESSING METHOD, APPARATUS, DEVICE, AND STORAGE MEDIUM

(71) Applicant: BEIJING BAIDU NETCOM SCIENCE TECHNOLOGY CO., LTD., Beijing (CN)

(72) Inventors: Yan Zeng, Shenzhen (CN); Junliang Deng, Beijing (CN); Xiuwei Lin, Beijing (CN); Shengfeng Liang, Beijing (CN); Gaopeng Mo, Beijing (CN); Geli Guo, Beijing (CN)

(21) Appl. No.: 17/487,363

(22) Filed: Sep. 28, 2021

(30) Foreign Application Priority Data
Dec. 28, 2020 (CN) 2020115893495

(51) Int. Cl. G01C 21/00; G01C 21/34; G06T 17/05

(52) U.S. Cl. CPC G01C 21/3819; G01C 21/387; G06T 17/05; G01C 21/3453; G01C 21/3822

(57) ABSTRACT

This application discloses a road data processing method, an apparatus, a device and a storage medium, and relates to the technical fields of intelligent traffic in data processing, big data and cloud computing. The specific implementation solution is: obtaining shape information of a target road and shape information of a reference road; generating a first segment sequence according to the shape information of the target road; generating a second segment sequence according to the shape information of the reference road; and recognizing parallel road segments in the target road and the reference road according to the first segment sequence and the second segment sequence. Thus, by converting the target road and the reference road into sequences of segments respectively, parallel road segments are recognized in the target road and the reference road based on the sequences of segments, the efficiency and accuracy are improved in recognizing parallel roads.

### CROSS-REFERENCE TO RELATED APPLICATIONS

This application claims priority to Chinese Patent Application No. 2020115893495, filed on Dec. 28, 2020, entitled “ROAD DATA PROCESSING METHOD, APPARATUS, DEVICE, AND STORAGE MEDIUM”, which is incorporated herein by reference in its entirety.

### TECHNICAL FIELD

This application relates to the technical fields of intelligent traffic in data processing, big data and cloud computing, and in particular to a road data processing method, an apparatus, a device, and a storage medium.

### BACKGROUND

A traffic network refers to an artificial network of traffic roads describing the layout of roads. There are parallel roads in the traffic network, the recognition of which helps further refining the road layout in the traffic network, as well as operating other businesses based on the traffic network, such as navigation, road 3D modeling, etc.

When recognizing parallel roads, an electronic map can be loaded and displayed, and then either manually examines whether two roads are parallel, or recognize similar roads using Frechet algorithm. However, the assessment standard of manual observation lacks objectivity, while Frechet algorithm does not have very high accuracy in measuring road similarity.

Therefore, how to improve the accuracy in recognizing parallel roads is a critical problem to be solved.

### SUMMARY

This application provides a road data processing method, an apparatus, a device and a storage medium.

According to a first aspect of this application, a road data processing method is provided, including:

obtaining shape information of a target road and shape information of a reference road;

generating a first segment sequence according to the shape information of the target road;

generating a second segment sequence according to the shape information of the reference road; and

recognizing parallel road segments in the target road and the reference road according to the first segment sequence and the second segment sequence.

According to a second aspect of this application, a road data processing apparatus is provided, including:

an obtaining unit, configured to obtain shape information of a target road and shape information of a reference road;

a sequence generating unit, configured to generate a first segment sequence according to the shape information of the target road; and generate a second segment sequence according to the shape information of the reference road; and

a recognizing unit, configured to recognize parallel road segments in the target road and the reference road according to the first segment sequence and the second segment sequence.

According to a third aspect of this application, an electronic device is provided, including:

at least one processor; and

a memory communicatively connected with the at least one processor, where:

the memory stores thereon instructions executable by the at least one processor to enable the at least one processor to implement the method according to the first aspect.

According to a fourth aspect of this application, a non-transitory computer-readable storage medium is provided, storing thereon computer instructions that enable a computer to implement the method according to the first aspect.

According to a fifth aspect of this application, a computer program product is provided, including a computer program stored in a readable storage medium, and at least one processor of an electronic device may read from the readable storage medium the computer program which, when executed by the at least one processor, enables the electronic device to implement the method according to the first aspect.

It should be understood that what is described in this section is not intended to identify critical or important features of embodiments of this application, nor is it intended to limit the scope of this application. Other features of this application will become readily comprehensible with the following specification.

### BRIEF DESCRIPTION OF THE DRAWINGS

The drawings are used to facilitate understanding of this solution, and do not constitute any limitation on this application. In the drawings:

FIG. 1 is a first illustrative diagram of two parallel roads;

FIG. 2 is a second illustrative diagram of two parallel roads;

FIG. 3 is an illustrative diagram of an application scenario in which an embodiment of this application can be implemented;

FIG. 4 is a schematic flowchart of a road data processing method provided in accordance with an embodiment of this application;

FIG. 5 is a schematic flowchart of a road data processing method provided in accordance with another embodiment of this application;

FIG. 6 is a schematic flowchart of a road data processing method provided in accordance with another embodiment of this application;

FIG. 7 is a schematic flowchart of a road data processing method provided in accordance with another embodiment of this application;

FIG. 8(a), FIG. 8(b), and FIG. 8(c) are illustrative diagrams of matching curve graphs provided according to another embodiment of this application;

FIG. 9 is a schematic structural diagram of a road data processing apparatus provided in accordance with an embodiment of this application; and

FIG. 10 is a block diagram of an electronic device for implementing a road data processing method according to an embodiment of this application.

### DESCRIPTION OF EMBODIMENTS

Now, exemplary embodiments of this application will be described with reference to the accompanying drawings, which include various details of the embodiments of this application to facilitate understanding, and shall be considered as merely exemplary. Therefore, those of ordinary skill in the art should appreciate that various changes and modifications can be made to the embodiments described herein without departing from the scope and spirit of this application. Also, for clarity and conciseness, descriptions of well-known functions and structures are omitted in the following description.

A traffic network refers to an artificial network of traffic roads describing the layout of roads. Recognition of parallel roads in the traffic network helps further refining the road layout in the traffic network, as well as operating businesses based on the traffic network, such as navigation, road 3D modeling, etc.

In geometry, parallel lines means that two lines in a common plane do not have any common point, which implies that the directions of two lines change the same way at the same time, including changes of the same magnitude in the same direction. As for roads in the real world, which are restricted by the terrain and the accuracy factor when manually plotting the road shape, two roads in a common traffic space are considered parallel or partially parallel when all or some road segments of the two roads essentially stretches along the same direction.

One approach to recognize parallel roads in a traffic network includes loading and displaying the traffic network on an electronic map, and then manually assess the parallelism in the roads in the electronic map displayed on the screen of the device. This approach has its shortcomings. First, the massive number of roads in the traffic network means heavy workload in manually assessing whether these roads are parallel, so the efficiency is not high, and the labor cost is high. Second, the manual assessment depends on the experience and subjective perception of the assessor, which does not have very high accuracy.

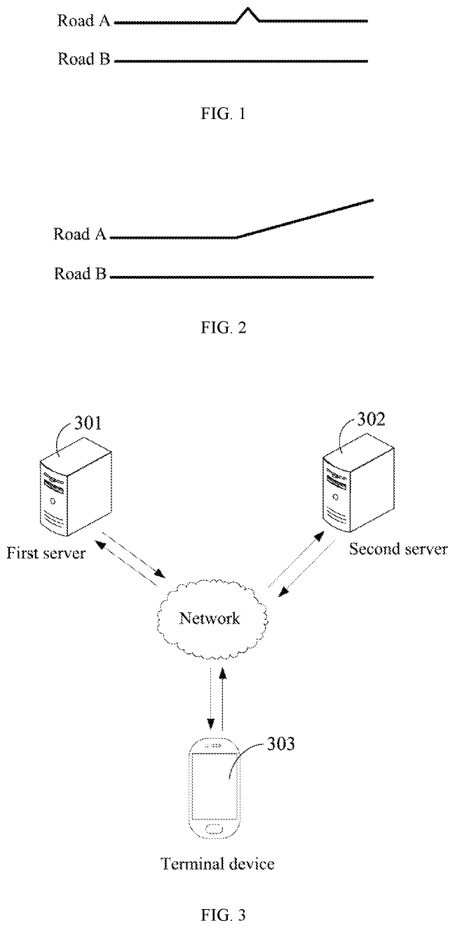

Another approach to improve the efficiency in road parallelism assessment includes using a path space similarity algorithm to determine whether two roads are parallel. Take the Frechet algorithm as an example, the Frechet algorithm calculates the Frechet distance between two roads, and determines whether the two roads are parallel based on the Frechet distance. The Frechet algorithm is a method to measure the spatial path similarity, which is a simple and intuitive way to measure similarity and can achieve desirable results in most cases, but which has the following shortcomings when applied to the calculation of road parallelism. First, as shown in FIG. 1, although road A and road B are parallel to each other, if there is a corner in road A but no corner in the corresponding position of road B, the Frechet distance will significantly increase, resulting in that the two roads are deemed not parallel. Second, the Frechet distance requires two roads be aligned with regard to their starting points and ending points; while if two parallel roads are unaligned with regard to their starting points and ending points, the two roads will be deemed not parallel. Third, as shown in FIG. 2, when some segments of road A and road B are parallel to each other while others are not, the Frechet algorithm tends to deem that the road A and road B are not parallel when performing parallel recognition on the two roads.

It can be seen that the accuracy in parallel road recognition still needs to be improved.

This application provides a road data processing method, an apparatus, a device and a storage medium that are applied to the technical fields of intelligent traffic in data processing, big data and cloud computing in order to achieve improved accuracy in parallel road recognition.

FIG. 3 is an illustrative diagram of an application scenario to which an embodiment of this application is applicable. As shown in FIG. 3, the application scenario includes: a first server 301 and a second server 302, where the first server 301 and the second server 302 communicate with each other, e.g., via a network. The first server 301 stores thereon road data in a traffic network, and the second server 302 can obtain from the first server 301 the road data in the traffic network and perform parallelism recognition on different roads in the road data. After recognizing the parallel roads in the traffic network, the second server 302 can return the results to the first server 301 for further refinement of the traffic network in the first server 301.

Optionally, as shown in FIG. 3, the application scenario further includes a terminal device 303 which can communicate with the second server 302, e.g., via a network. The second server 302 can, after recognizing parallel roads in the traffic network, return the results to the terminal device 303 to support a road business on the terminal device 303, such as a navigation business or a road 3D modeling business.

The terminal device 303 may be a personal digital assistant (PDA) device, a handheld device with wireless communication capability (e.g., a smart phone, a tablet computer), a computing device (e.g., a personal computer (PC)), a vehicle mounted device, a wearable device (e.g., a smart watch, a smart bracelet), and a smart home device (e.g., a smart display device), etc. A smart phone has been used as an example in FIG. 3. The first server 301 and the second server 302 may be centralized servers, distributed servers, or cloud-based servers.

Illustratively, the execution subject of the road data processing method provided by embodiments of this application may be the first server 301 as shown in FIG. 3. It may also be other electronic devices communicating with the second server 302, such as a computer, a tablet computer, a vehicle mounted electronic device, etc.

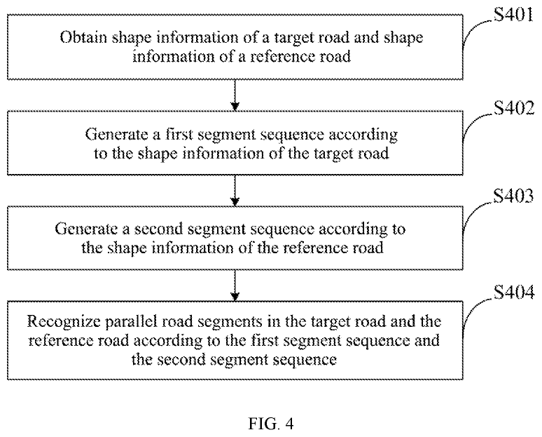

FIG. 4 is a schematic flowchart of a road data processing method provided in accordance with an embodiment of this application. As shown in FIG. 4, the method includes:

S401: obtain shape information of a target road and shape information of a reference road.

In an example, the target road is, e.g., one or more roads in the road data of the traffic network, and the reference road is one or more roads in the road data of the traffic network that satisfy a preset condition with the geographic location of the target road. The preset condition is, for example, that the reference road is located within the same geographic area as the target road, such as located in the same province, located in the same city. Or, the preset condition is, for another example, that the geographic distance between the reference road and the target road is less than or equal to a preset distance threshold.

In another example, the target road is one or more roads selected and designated by a user in the road data of the traffic network, and the reference road is one or more roads in the road data of the traffic network whose geographic location with the target road satisfies a preset condition. Or, the reference road is one or more roads selected and designated by the user in the road data of the traffic network for parallelism recognition with the target road.

For example, an electronic map corresponding to the traffic network may be displayed on a display screen of a terminal device, on which the user selects one or more roads to be the target road, and then selects one or more roads to be the reference road.

The shape information of the target road is used to depict the shape and direction of the target road, and the shape information of the reference road is used to describe the shape and direction of the reference road.

In an example, in the road data of the traffic network, a road may be described by multiple shape points in that the road may be depicted by sequentially joining the shape points along the road. Shape points on a road are located at places where the shape of the road changes, such as at corners of the road, and removing a shape point from the road will change the shape of the road.

Thus, the shape information of the target road includes the location information of multiple shape points on the target road, and the shape information of the reference road includes the location information of multiple shape points on the reference road. When obtaining the shape information of the target road and the shape information of the reference road, the location information of the plurality of shape points on the target road and the location information of the plurality of shape points on the reference road can be obtained from the road data of the traffic network collected in advance. Location information of a shape point is, e.g., the latitude and longitude of the shape point.

In another example, a map image including the target road and the reference road can be obtained, such as receiving a map image input by a user. Road recognition is performed on this map image to obtain the shape information of the target road on the map image and the shape information of the target road on the map image. In this case, the shape information of the target road can include a contour image of the target road on the map image, and the shape information of the reference road can include a contour image of the reference road on the map image. Or, a shape point on the target road can be determined at a location on the contour image of the target road where the shape of the target road changes, and the location information of multiple shape points can be combined to derive the shape information of the target road. Similarly, the location information of multiple shape points on the reference road can be combined to derive the shape information of the reference road. In this case, the location information of the shape point is, e.g., the pixel position of the shape point on the map image.

S402: generate a first segment sequence according to the shape information of the target road.

The first segment sequence includes segment information of multiple segments on the target road. In the first segment sequence, respective segments are arranged in order of their own positions along the target road, with segment information of the respective segments including starting positions and ending positions of the respective segments. Optionally, in the first segment sequence, the segment information of the respective segments may also include length information of the respective segments.

In an example, if the shape information of the target road includes the location information of multiple shape points on the target road, the multiple shape points may be combined in pairs to obtain multiple segments on the target road, with each segment being represented by two shape points. Further, when combining the shape points in pairs, two adjacent shape points along the target road can be combined into a corresponding segment to ensure that respective segments have similar lengths while splitting the target road into multiple segments.

In another example, if the shape information of the target road includes the contour image of the target road, shape points on the target road can also be determined on the road contour of the target road to obtain multiple shape points on the target road, and multiple segments on the target road can be obtained by combining the shape points in pairs.

S403: generate a second segment sequence according to the shape information of the reference road.

The second segment sequence includes segment information of multiple segments on the reference road. In the second segment sequence, respective segments are arranged in order of their own positions along the reference road, with segment information of the respective segments including starting positions and ending positions of the respective segments. Optionally, in the second segment sequence, the segment information of the respective segments may also include length information of the respective segments.

In an example, if the shape information of the reference road includes the location information of multiple shape points on the reference road, the multiple shape points may be combined in pairs to obtain multiple segments on the reference road, with each segment being represented by two shape points. Further, when combining the shape points in pairs, two adjacent shape points along the reference road can be combined into a corresponding segment to ensure that the respective segments have similar lengths while splitting the reference road into multiple segments.

In another example, if the shape information of the reference road includes the contour image of the reference road, shape points on the reference road can also be determined on the road contour of the reference road to obtain multiple shape points on the reference road, and multiple segments on the reference road can be obtained by combining the shape points in pairs.

For ease of description, a segment in the first segment sequence will from now on be referred to as a first segment, and a segment in the second segment sequence a second segment.

S404: recognize parallel road segments in the target road and the reference road according to the first segment sequence and the second segment sequence.

As used herein, recognizing parallel road segments in the target road and the reference road means recognizing road segments that are parallel to each other across the target road and the reference road.

Specifically, because the first segment sequence is composed of multiple first segments obtained by splitting the target road, and the second segment sequence is composed of multiple second segments obtained by splitting the reference road, the first segment sequence and the second segment sequence can be assessed in similarity to determine whether the target road and the reference road are parallel in entirety or in part, and to determine road segments that are parallel to each other therebetween.

In an example, the first segments in the first segment sequence are assessed for parallelism with the second segments in the second segment sequence close to the first segments in a one-to-one manner to obtain one or more consecutive parallel segment pairs between the first segment sequence and the second segment sequence, with each segment pair including one first segment and one second segment. According to the first segments in the one or more consecutive parallel segment pairs, the road segments on the target road and parallel to the reference road can be determined. According to the second segments in the one or more consecutive parallel segment pairs, the road segments on the reference road and parallel to the target road can be determined.

In this embodiment, the target road is converted into a first segment sequence according to the shape information of the target road, the reference road is converted into a second segment sequence according to the shape information of the reference road. Based on the first segment sequence and the second segment sequence, parallel road segments between the target road and the reference road are determined, without requiring the target road and the reference road to conform with regard to their starting positions and ending positions, and parallelism can be recognized in part of road segments of the target road and the reference road, thus improving the accuracy in parallel road recognition.

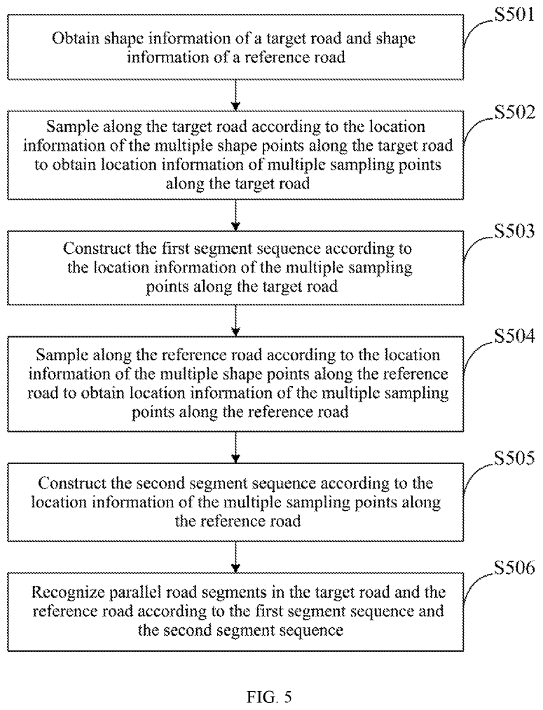

In the case where the shape information of the target road includes the location information of multiple shape points on the target road, the shape information of the reference road includes the location information of multiple shape points on the reference road, and the location information of the shape points includes, e.g., the latitude and longitude locations of the shape points, FIG. 5 is a schematic flowchart of a road data processing method provided in accordance with another embodiment of this application. As shown in FIG. 5, the method includes:

S501: obtain shape information of a target road and shape information of a reference road.

The implementation process of S501 can be found in the foregoing embodiments, which will not be repeated herein.

S502: sample along the target road according to the location information of the multiple shape points along the target road to obtain location information of multiple sampling points along the target road.

The multiple sampling points on the target road include multiple shape points and non-shape points on the target road. Non-shape points refers to sampling points on the road but irrelevant to the shape of the road. Removal of a non-shape point from the road has no or little influence on the shape of the road. For example, if a road segment between two shape points is a straight segment, multiple non-shape points can be sampled between the two shape points. Even if one or more of the non-shape points are removed, the road segment between the two shape points would remain a straight segment.

Specifically, considering the limited number of shape points on the target road, sampling can be applied to the target road according to the location information of multiple shape points along the target road to obtain the location information of the respective sampling points, so as to improve the accuracy in the parallelism recognition of the target road and the reference road.

In an example, sampling is performed according to a preset step size to obtain one or more non-shape points, which starts from a first shape point on the target road (typically the starting point of the target road) and ends until a last shape point of the target road (typically the ending point of the target road). The multiple shape points and non-shape points along the target road form the multiple sampling points along the target road.

Further, if a distance between a current sampling point and a next shape point is less than the preset step size while sampling starts from the first shape point on the target road according to the preset step size, the next shape point will be regarded as the next sampling point, from which the sampling starts according to the preset step size. This sampling continues until the last shape point, avoiding over finely dividing the target road.

S503: construct the first segment sequence according to the location information of the multiple sampling points along the target road.

The meaning of the first segment sequence can be found in the foregoing embodiments, which will not be repeated herein.

In an example, multiple sampling points are combined in pairs to obtain multiple first segments on the target road, with each first segment being represented by two sampling points. Further, when combining the sampling points in pairs, two adjacent sampling points along the target road can be combined into a corresponding first segment to ensure that the respective first segments have similar lengths while splitting the target road into multiple segments.

S504: sample along the reference road according to the location information of the multiple shape points along the reference road to obtain location information of the multiple sampling points along the reference road.

The multiple sampling points on the reference road include multiple shape points and non-shape points on the reference road. For the meaning of non-shape points, reference can be made to related description in the foregoing, which will not be repeated herein.

Specifically, considering the limited number of shape points on the reference road, sampling can be applied to the reference road according to the location information of multiple shape points along the reference road to obtain the location information of the respective sampling points, so as to improve the accuracy in the parallelism recognition of the target road and the reference road.

In an example, sampling is performed according to a preset step size to obtain one or more non-shape points, which starts from a first shape point on the reference road (typically the starting point of the reference road), and ends until a last shape point of the reference road (typically the ending point of the reference road). The multiple shape points and non-shape points along the reference road form the multiple sampling points along the reference road.

Further, if a distance between a current sampling point and a next shape point is less than the preset step size while sampling starts from the first shape point on the reference road according to the preset step size, the next shape point will be regarded as the next sampling point, from which the sampling starts according to the preset step size. This sampling continues until the last shape point, avoiding over finely dividing the reference road.

S505: construct the second segment sequence according to the location information of the multiple sampling points along the reference road.

In an example, multiple sampling points are combined in pairs to obtain multiple second segments on the reference road, with each second segment being represented by two sampling points. Further, when combining the sampling points in pairs, two adjacent sampling points along the reference road can be combined into a corresponding second segment to ensure that respective second segments have similar lengths while splitting the reference road into multiple segments.

S506: recognize parallel road segments in the target road and the reference road according to the first segment sequence and the second segment sequence.

The implementation process of S506 can be found in the foregoing embodiments, which will not be repeated herein.

In this embodiment, the target road is sampled according to the location information of multiple shape points along the target road to obtain the first segment sequence, and the second segment sequence is obtained according to the location information of the multiple shape points on the reference road, thus improving the efficiency in dividing the target road and the reference road. Based on the first segment sequence and the second segment sequence, parallel segments between the target road and the reference road are determined, without requiring the target road and the reference road to conform with regard to their starting positions and ending positions, and parallelism can be recognized in part of road segments of the target road and the reference road, thus improving the accuracy in parallel road recognition.

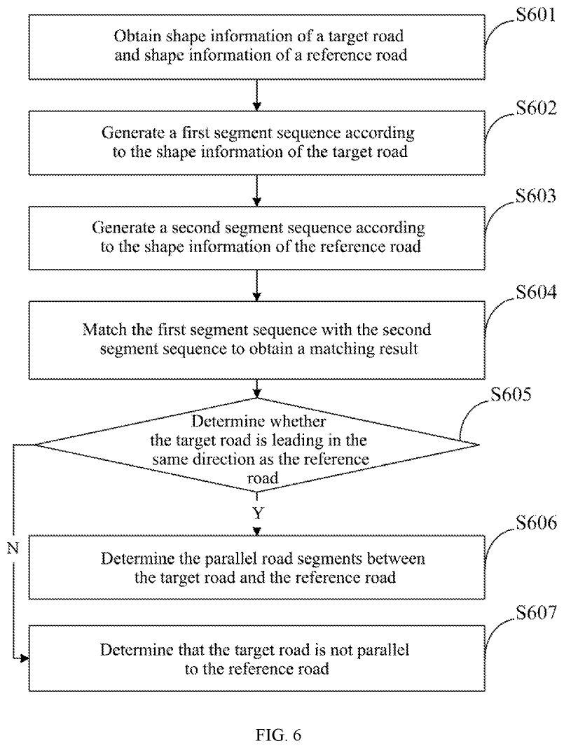

FIG. 6 is a schematic flowchart of a road data processing method provided in accordance with another embodiment of this application. As shown in FIG. 6, the method includes:

S601: obtain shape information of a target road and shape information of a reference road.

S602: generate a first segment sequence according to the shape information of the target road.

S603: generate a second segment sequence according to the shape information of the reference road.

The implementation process of S601-S603 can be found in the foregoing embodiments, which will not be repeated herein.

S604: match the first segment sequence with the second segment sequence to obtain a matching result.

Specifically, a sequence matching algorithm can be used to match the first segment sequence with the second segment sequence to determine the similarity between the first segment sequence and the second segment sequence. After the matching, a matching result is obtained, and the matching result includes matching cost values of multiple first segments with multiple second segments. The matching cost values of the first segments with the second segments reflect the similarity in terms of the directions of the first segments and the directions of the second segments. In other words, the matching cost values of the first segments with the second segments reflect the degree of parallelism between the first segments and the second segments, e.g., higher matching cost values mean lower parallelism. Therefore, the matching result can reflect the similarity between the first segment sequence and the second segment sequence, thus better reflecting the similarity between the road direction of the target road and the road direction of the reference road. For example, a higher matching result means lower similarity.

Optionally, for the sequence matching algorithm, a dynamic time warping (DTW) algorithm is used. The DTW algorithm was originally used to measure the similarity between two time series that may be different in length. In this embodiment, the first segment sequence and the second segment sequence can be used as the input to the DTW algorithm, and angles between segments are used as a cost function of the DTW algorithm to obtain the matching result output from the DTW. Because the matching cost values in the matching result output from the DTW algorithm are determined based on the angles between the first segments and the second segments, the similarity between the first segment sequence and the second segment sequence reflected by the matching result ultimately reflects the similarity between the road direction of the target road and the road direction of the reference road.

S605: determine whether the target road is leading in the same direction as the reference road.

The direction of the road may be, e.g., east-west, north-south, etc. Having the same direction is a precondition to having parallel segments between the target road and the reference road. For example, if a target road runs east-west while a reference road runs north-south, there may be no parallel road segment between the target road and the reference road. Therefore, it is possible to first determine whether the road direction of the target road is the same as the road direction of the reference road, and then determine the parallel segments between the target road and the reference road under the precondition that their directions are the same.

Specifically, it can be determined whether the target road is leading in the same direction as the reference road according to the matching result of the first segment sequence with the second segment sequence.

In an example, a sum of respective matching cost values in the matching result is compared with a preset matching threshold. If the sum of the matching cost values is greater than the matching threshold, it can be deemed that the road direction of the target road is quite different from the road direction of the reference road, and hence there is no parallel road segment between the target road and the reference road. Therefore, the road direction of the target road is determined to be different from the road direction of the reference road. If the sum of the matching cost values is less than the matching threshold, it can be deemed that there are parallel road segments between the target road and the reference road, and the road segments may be parallel in entirety or in part. Therefore, the road direction of the target road is determined to be the same as the road direction of the reference road.

In another example, considering a fact that a longer target road entails a sum of respective matching cost values in a matching result being greater, the length of the target road can be obtained when determining, based on the matching result, whether the road direction of the target road is the same as the road direction of the reference road. A rate of change of the matching result relative to the road length of the target road and is determined, if the rate of change meets a preset condition, the road direction of the target road is determined to be the same as the road direction of the reference road, thus improving the accuracy of determining whether their road directions are the same.

Further, a ratio of the sum of the respective matching cost values in the matching result to the road length of the target road can be calculated. This ratio is determined to be the rate of change of the matching result relative to the road length of the target road, and the rate of change is compared with a preset rate of change threshold. If the rate of change is greater than the rate of change threshold, the road direction of the target road is determined to be different from the road direction of the reference road. Otherwise, the road direction of the target road is determined to be the same as the road direction of the reference road.

Therefore, if the road direction of the target road is determined to be the same as the road direction of the reference road, S606 is executed. Otherwise, S607 is executed.

S606: determine the parallel road segments between the target road and the reference road.

Specifically, the matching result includes matching cost values of multiple first segments with multiple second segments. The matching cost values of the first segments with the second segments reflect the similarity in terms of the directions of the first segments and the directions of the second segments. Therefore, after determining that the direction of the target road is the same as the direction of the reference road, parallel road segments between the target road and the reference road can be determined based on the respective matching cost values in the matching result.

S607: determine that the target road is not parallel to the reference road.

In this embodiment, the target road is converted into a first segment sequence, and the reference road is converted into a second segment sequence. Based on the matching result of the first segment sequence with the second segment sequence, the parallel road segments between the target road and the reference road are determined under a precondition that the roads have the same direction, thus improving the accuracy and efficiency in parallel road recognition.

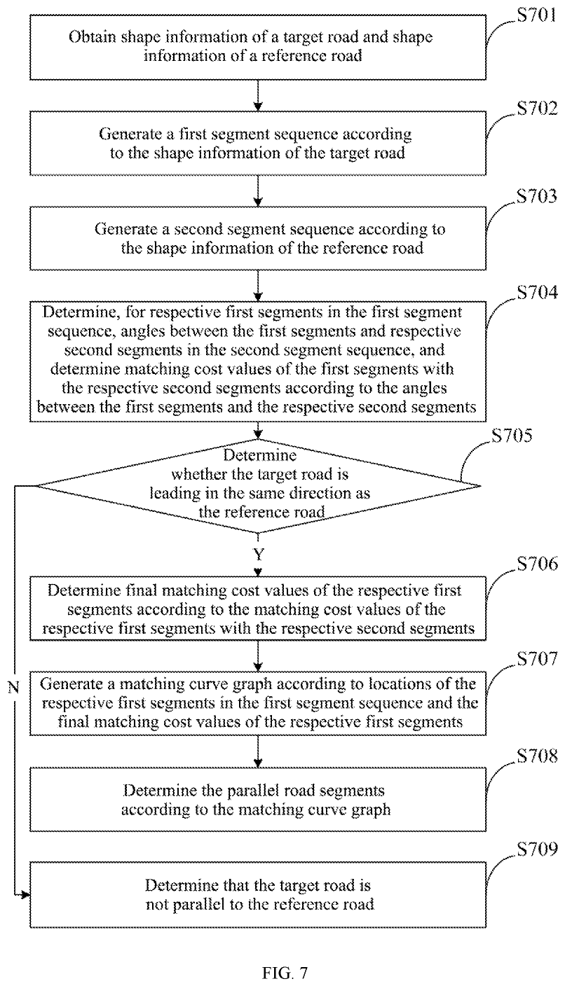

FIG. 7 is a schematic flowchart of a road data processing method provided in accordance with another embodiment of this application. As shown in FIG. 7, the method includes:

S701: obtain shape information of a target road and shape information of a reference road.

S702: generate a first segment sequence according to the shape information of the target road.

S703: generate a second segment sequence according to the shape information of the reference road.

The implementation process of S701-S703 can be found in the foregoing embodiments, which will not be repeated herein.

S704: determine, for respective first segments in the first segment sequence, angles between the first segments and respective second segments in the second segment sequence, and determine matching cost values of the first segments with the respective second segments according to the angles between the first segments and the respective second segments.

Specifically, after the first segment sequence and the second segment sequence are obtained, respective first segments in the first segment sequence are matched with respective second segments in the second segment sequence to obtain matching cost values of the respective first segments with the respective second segments. The matching cost values of the respective first segments with the respective second segments form a matching result of the first segment sequence with the second segment sequence.

Specifically, in the process of matching the respective first segments with the respective second segments, the starting and ending positions of the first segment are known, the starting and ending positions of the second segment are known, and the angles between the first segments and the second segments can reflect whether the first segments are parallel to the second segments, and hence for the respective first segments in the first segment sequence, the angles between the first segments and the respective second segments in the segment sequence can be determined, and the matching cost values of the first segments with the respective second segments can be determined according to the angles between the first segments and the respective second segments.

In a possible implementation, the process of determining the angles between the first segments and respective second segments in the segment sequence and determining the matching cost values of the first segments with the respective second segments according to the angles between the first segments and the respective second segments includes: determining, for each of the second segments: an angle between the first segment and the second segment; obtaining multiple neighbor matching cost values; and determining the matching cost value of the first segment with the second segment according to the respective neighbor matching cost values and the angle between the first segment and the second segment. Therefore, in view of the fact that the parallelism of two segments between roads is not only affected by the angle between the two segments themselves, but also by the parallelism between the adjacent segments of the two segments, neighbor matching cost values are considered in addition to the angle between the first segment and the second segment when determining the matching cost value of the first segment with the second segment, thus improving the accuracy of the matching result of the first segment sequence with the second segment sequence.

Multiple neighbor matching values include a matching cost value of the first segment with a previous segment of the second segment, a matching cost value of a previous segment of the first segment with the second segment, and a matching cost value of a previous segment of the first segment with a previous segment of the second segment. In the matching process of the first segment sequence with the second segment sequence, sequentially determine the matching cost values of the first segments in the first segment sequence with respective second segments in the second segment sequence, corresponding to two levels of loops, in which a first level of loop begins from the first one of the first segments until the last one in the first segment sequence, and a second level of loop begins from the first one of the second segments until the last one in the second segment sequence. Therefore, when determining the matching cost values of the first segments with the second segments, multiple neighbor matching values are known values.

Illustratively, the matching result is regarded as a matrix whose number of rows is the number of the first segments, number of columns is the number of the second segments, with each element in the matrix being a matching cost value of a corresponding first segment with a second segment. For an element corresponding to a matching cost value of a first segment with a second segment, the neighbor matching cost values are neighbor elements located directly to the left, directly above, and upper left of the element in the matrix of the matching result.

Further, the process of determining the matching cost value of the first segment with the second segment according to the respective neighbor matching cost values and the angle between the first segment and the second segment includes: obtaining a minimum neighbor matching cost value among the multiple neighbor matching cost values; and determining the matching cost value of the first segment with the second segment according to a sum of a value of the angle between the first segment and the second segment and the minimum neighbor matching cost value. Therefore, by selecting the minimum neighbor matching cost value and adding the same to the value of the angle between the first segment and the second segment, optimization is realized for the matching cost value of the first segment with the second segment in the matching. An optimal matching cost value of the first segment with the second segment is determined, thereby improving the accuracy of parallel road recognition between the target road and the reference road.

S705: determine whether the target road is leading in the same direction as the reference road.

The implementation process of S705 can be found in the foregoing embodiments, which will not be repeated herein.

If the road direction of the target road is determined to be the same as the road direction of the reference road, S706 is executed. Otherwise, S709 is executed.

S706: determine final matching cost values of the respective first segments according to the matching cost values of the respective first segments with the respective second segments.

Specifically, after determining that the road direction of the target road is the same as the road direction of the reference road, it can be derived that there is very likely a parallel road segment in the target road. Therefore, parallel segments between the target road and the reference road can be determined according to the matching result of the first segment sequence with the second segment sequence. As used herein, S706-S708 are operations for determining the parallel segment in the target road.

Specifically, when the matching result of the first segment sequence and the second segment sequence includes matching cost values of respective first segments with respective second segments, for the respective first segments, their final matching cost values can be determined out of the matching cost values of the first segments with the respective second segments, and finally obtaining the final matching cost values of the respective first segments, so as to reflect the degree of parallelism between the segments on the target road and the segments on the reference road using the final matching cost values of the respective first segments.

In an example, when determining final matching cost values of first segments out of the matching cost values of the first segments with the respective second segments, a matching cost value of a first segment with a second segment having the closest geographic distance to the first segment can be determined to be a final matching cost value of the first segment.

In another example where the matching cost value of the first segment with the second segment is the sum of the angle between the first segment and the second segment and the minimum neighbor matching cost value among multiple neighbor matching cost values, the matching process will undergo continuous iterations of optimizations until the accuracy of the matching cost value of the last first segment in the first segment sequence with the last second segment in the second segment sequence is maximum. Thus, the matching cost values of the first segments with the second segments in a one-to-one correspondence following an order from back to front in the first segment sequence and an order from back to front in the second segment sequence may be determined to be the final matching cost values of the first segments. In other words, the matching cost value of the last first segment with the last second segment is determined to be the final matching cost value of the last first segment, and the matching cost value of the second last first segment with the second last second segment is determined to be the final matching cost value of the second last first segment. This loop goes on until the final matching cost values of the respective first segments are eventually obtained.

S707: generate a matching curve graph according to locations of the respective first segments in the first segment sequence and the final matching cost values of the respective first segments.

Specifically, with the positions of the first segments in the first segment sequence forming the horizontal coordinates and the final matching values of the first segments forming the longitudinal coordinates, a two dimensional coordinate point is created. As such, multiple coordinate points can be obtained, which are connected sequentially, deriving a matching curve graph.

The matching curve graph reflects the changes in the final matching cost values of the first segments as the positions of the first segments in the first segment sequence change. Therefore, the matching curve graph ultimately reflects the change in the degree of parallelism between multiple road segments on the target road and the multiple road segments on the reference road.

S708: determine the parallel road segments according to the matching curve graph.

This embodiment aims at determining the road segment on the target road and parallel to the reference road. Thus, the parallel road segment is located on the target road, and the number thereof can be one or more.

Specifically, after the matching curve graph has been created, a curve segment that satisfies a given condition can be determined according to the change of the longitudinal coordinates of the matching curve graph. For example, the condition could be that slopes of respective points on the curve segment are all less than a preset slope threshold. According to the range of the horizontal coordinates corresponding to the curve segment that meets the given condition, the road segment parallel to the reference road and on the target road is determined. For example, when the curve segment whose change of longitudinal coordinates satisfies the given condition corresponds to a horizontal coordinate range of 5 to 10, it can be determined that road segments that are on the target road and parallel to the reference road are those between the fifth and the tenth first segments in the first segment sequence.

If no curve segment meets the given condition, it is determined that the target road and the reference road are not parallel.

In an example, in the process of determining the parallel road segments according to the matching curve graph, a first coordinate point and a second coordinate point can be determined in the matching curve graph to obtain a longitudinal coordinate difference and a horizontal coordinate difference between the first coordinate point and the second coordinate point. A ratio of the obtained longitudinal coordinate difference to the obtained horizontal coordinate difference is computed. If the ratio is less than a preset threshold, it means that the final matching cost values of respective first segments between the first coordinate point and the second coordinate point change very little or essentially remain the same, which further means the road segments formed by the respective first segments between the first coordinate point and the second coordinate point are essentially parallel with the reference road. Thus, it can be deemed that road segments formed by the respective first segments between the first coordinate point and the second coordinate point are a parallel road segment with relative to the reference road.

Therefore, when the ratio of the longitudinal coordinate difference between the first coordinate point and the second coordinate point to the horizontal coordinate difference between the first coordinate point and the second coordinate point is less than the preset threshold, it can be determined that the curve segment between the first coordinate point and the second coordinate point satisfies a given condition. Further, a horizontal coordinate range between the first coordinate point and the second coordinate point is determined, according to which the parallel road segments between the target road and the reference road are determined on the target road.

In an example, the first coordinate point and the second coordinate point can be arbitrarily sampled on the matching curve graph.

In another example, the process of determining the first coordinate point and the second coordinate point in the matching curve graph includes: determining a reference segment in the matching curve graph according to a starting point and an ending point of the matching curve graph; if the matching curve graph is disposed on both sides of the reference segment, determining a coordinate point on the matching curve graph on one side of the reference segment and farthest from the reference segment to be the first coordinate point, and determining a coordinate point on the matching curve graph on the other side of the reference segment and farthest from the reference segment to be the second coordinate point; if the matching curve graph is disposed above the reference segment, determining a coordinate point on the matching curve graph farthest from the reference segment to be the first coordinate point, and determining the ending point of the matching curve graph to be the second coordinate point; if the matching curve graph is disposed below the reference segment, determining a coordinate point on the matching curve graph farthest from the reference segment to be the first coordinate point, and determining the starting point of the matching curve graph to be the second coordinate point. Thus, the accuracy and efficiency is improved for determining the first coordinate point and the second coordinate point.

The starting point and the ending point of the matching curve graph can be connected by a straight line, with the segment thereon joining the starting point and the ending point being determined to be the reference segment of the matching curve graph.

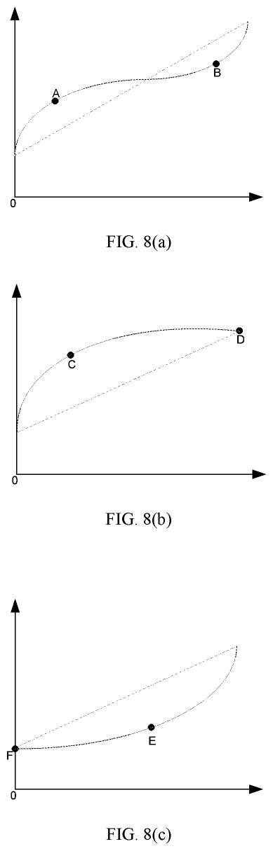

FIG. 8(a), FIG. 8(b), and FIG. 8(c) are illustrative diagrams of matching curve graphs (i.e., the solid line curve in the drawing) that are disposed on both sides, an upper side and a lower side, respectively, of the reference segment (i.e., the dashed line in the drawing). As shown in FIG. 8(a), the point A on the matching curve on one side of the reference segment and farthest from the reference segment is determined to be the first coordinate point, while the point B on the matching curve on the other side of the reference segment and farthest from the reference segment is determined to be the second coordinate point. As shown in FIG. 8(b), the coordinate point C on the matching curve graph and farthest from the reference segment is determined to be the first coordinate point, while the ending point D on the matching curve graph is determined to be the second coordinate point. As shown in FIG. 8(c), the coordinate point E on the matching curve graph and farthest from the reference segment is determined to be the first coordinate point, while the starting point F on the matching curve graph is determined to be the second coordinate point.

Further, in addition to verifying whether a ratio of the longitudinal coordinate difference to the horizontal coordinate difference between the first coordinate point and the second coordinate point is less than the preset threshold, a corresponding angle can also be calculated based on the ratio and, if the angle is less than a preset angle threshold, it can be determined that the curve segment between the first coordinate point and the second coordinate point satisfies a given condition. The equation for calculating the angle θ can be, e.g.:

θ=arctan(H/L), where H represents the longitudinal coordinate difference between the first coordinate point and the second coordinate point, and L represents the horizontal coordinate difference between the first coordinate point and the second coordinate point.

S709: determine that the target road is not parallel to the reference road.

In this embodiment, the first segments are matched with the second segments based on the angles therebetween, thus improving the accuracy in matching the first segment sequence with the second segment sequence. Based on the final matching cost values of the first segments, a matching curve graph is constructed, using which parallel road segments are determined, thus improving the accuracy and efficiency in parallel road segment recognition.

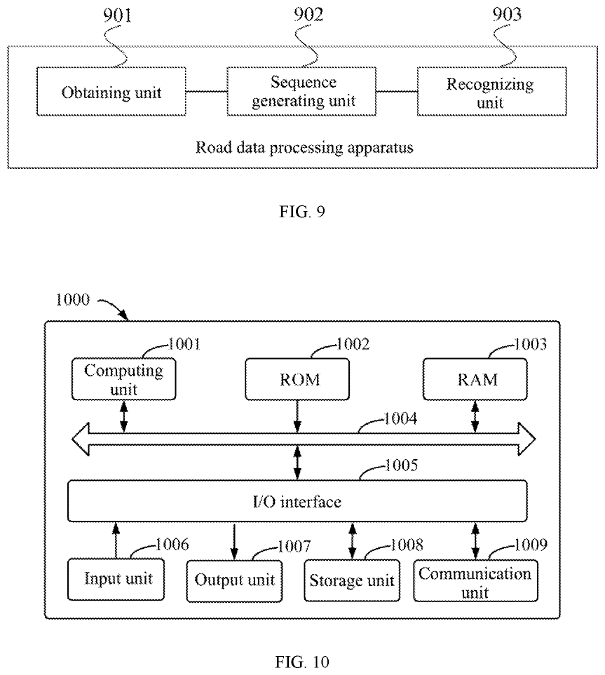

FIG. 9 is a schematic structural diagram of a road data processing apparatus provided in accordance with an embodiment of this application. As shown in FIG. 9, the apparatus includes:

an obtaining unit 901, configured to obtain shape information of a target road and shape information of a reference road;

a sequence generating unit 902, configured to generate a first segment sequence according to the shape information of the target road; and generate a second segment sequence according to the shape information of the reference road; and

a recognizing unit 903, configured to recognize parallel road segments in the target road and the reference road according to the first segment sequence and the second segment sequence.

In a possible implementation, the shape information of the target road includes location information of multiple shape points along the target road, and the shape information of the reference road includes location information of multiple shape points along the reference road, and a sampling point includes multiple shape points and multiple non-shape points, and the sequence generating unit 902 includes:

a target road sampling module, configured to sample along the target road according to the location information of the multiple shape points along the target road to obtain location information of multiple sampling points along the target road;

a first sequence constructing module, configured to construct the first segment sequence according to the location information of the multiple sampling points along the target road;

a reference road sampling module, configured to sample along the reference road according to the location information of the multiple shape points along the reference road to obtain location information of the multiple sampling points along the reference road; and

a second sequence constructing module, configured to construct the second segment sequence according to the location information of the multiple sampling points along the reference road.

In a possible implementation, the first sequence constructing module includes:

a first sequence constructing sub-module, configured to form a segment on the target road out of two adjacent sampling points along the target road to obtain the first segment sequence;

and the second sequence constructing module includes:

a second sequence constructing sub-module, configured to form a segment on the reference road out of two adjacent sampling points along the reference road to obtain the second segment sequence.

In a possible implementation, the recognizing unit 903 includes:

a matching module, configured to match the first segment sequence with the second segment sequence to obtain a matching result; and

a parallel road segment determining module, configured to determine, according to the matching result, parallel road segments of the target road and the reference road if the target road is found leading in the same direction as the reference road.

In a possible implementation, the matching result includes matching cost values of respective first segments in the first segment sequence with respective second segments in the second segment sequence, and the matching module includes:

a cost value determining module, configured to: determine, for respective first segments in the first segment sequence, angles between the first segments and respective second segments in the second segment sequence, and determine the matching cost values of the first segments with the respective second segments according to the angles between the first segments and the respective second segments,

where the matching cost values of the first segments with the respective second segments reflects a similarity between directions of the first segment and directions of the respective second segments.

In a possible implementation, the cost value determining module includes:

an angle determining module, configured to: determine, for each of the second segments, an angle between the first segment and the second segment;

a neighbor cost value obtaining module, configured to obtain multiple neighbor matching cost values, where the neighbor matching cost values include a matching cost value of the first segment with a previous segment of the second segment, a matching cost value of a previous segment of the first segment with the second segment, and a matching cost value of a previous segment of the first segment with a previous segment of the second segment; and

a cost value determining sub-module, configured to determine a matching cost value of the first segment with the second segment according to the respective neighbor matching cost values and the angle between the first segment and the second segment.

In a possible implementation, the cost value determining sub-module is configured to:

obtain a minimum neighbor matching cost value among the multiple neighbor matching cost values; and

determine the matching cost value of the first segment with the second segment according to a sum of a value of the angle between the first segment and the second segment and the minimum neighbor matching cost value.

In a possible implementation, the parallel road segment determining module includes:

a final cost value determining module, configured to determine final matching cost values of the respective first segments according to the matching cost values of the respective first segments with the respective second segments;

a curve graph generating module, configured to generate a matching curve graph according to locations of the respective first segments in the first segment sequence and the final matching cost values of each of the respective first segments; and

a parallel road segment determining sub-module, configured to determine the parallel road segments according to the matching curve graph.

In a possible implementation, the final cost value determining module includes:

a final cost value determining sub-module, configured to determine the matching cost values of the first segments with the second segments in a one-to-one correspondence following an order from back to front in the first segment sequence and an order from back to front in the second segment sequence, to be the final matching cost values of the first segments.

In a possible implementation, the parallel road segment determining sub-module is configured to:

determine a first coordinate point and a second coordinate point in the matching curve graph;

obtain a longitudinal coordinate difference and a horizontal coordinate difference between the first coordinate point and the second coordinate point;

determine a horizontal coordinate range between the first coordinate point and the second coordinate point if a ratio of the longitudinal coordinate difference to the horizontal coordinate difference is less than a preset threshold; and

determine the parallel road segment on the target road according to the horizontal coordinate range.

In a possible implementation, the parallel road segment determining sub-module is further configured to:

determine a reference segment in the matching curve graph according to a starting point and an ending point of the matching curve graph;

if the matching curve graph is disposed on both sides of the reference segment, determine a coordinate point on the matching curve graph on one side of the reference segment and farthest from the reference segment to be the first coordinate point, and determine a coordinate point on the matching curve graph on the other side of the reference segment and farthest from the reference segment to be the second coordinate point.

In a possible implementation, the parallel road segment determining sub-module is further configured to:

if the matching curve graph is disposed above the reference segment, determine a coordinate point on the matching curve graph farthest from the reference segment to be the first coordinate point, and determine the ending point of the matching curve graph to be the second coordinate point.

In a possible implementation, the parallel road segment determining sub-module is further configured to:

if the matching curve graph is disposed below the reference segment, determine a coordinate point on the matching curve graph farthest from the reference segment to be the first coordinate point, and determine the starting point of the matching curve graph to be the second coordinate point.

In a possible implementation, the recognizing unit 903 further includes:

a road length obtaining module, configured to obtain a road length of the target road;

a rate of change determining module, configured to determine a rate of change of the matching result relative to the road length of the target road; and

a direction determining module, configured to determine that the target road is leading in the same direction as the reference road if the rate of change satisfies a preset condition.

The device for presenting the map search result as provided in FIG. 9 can implement the foregoing corresponding method embodiments following similar implementation principles and producing similar technical effects, which will not be repeated herein.

According to embodiments of this application, this application further provides an electronic device and a readable storage medium.

According to an embodiment of this application, a computer program product is provided, including a computer program stored in a readable storage medium, and at least one processor of an electronic device may read from the readable storage medium the computer program which, when executed by the at least one processor, enables the electronic device to implement the solution provided in any of the foregoing embodiments.

FIG. 10 shows a schematic block diagram of an example electronic device 1000 that can be used to implement embodiments of this application. The electronic device is intended to represent a digital computer in various forms, such as a laptop computer, a desktop computer, a workstation, a personal digital assistant, a server, a blade server, a mainframe computer, and other appropriate computers. The electronic device may also represent a mobile device in various forms, such as a personal digital processing, a cellular phone, a smart phone, a wearable device, and other similar computing devices. The components, their connections and relationships, and their functions as illustrated herein are merely examples, and are not intended to limit the implementation of this disclosure described and/or required herein.

As shown in FIG. 10, the electronic device 1000 includes a computing unit 1001 that can carry out various appropriate actions and processing based on a computer program stored in a read-only memory (ROM) 1002 or a computer program loaded from a storage unit 1008 into a random access memory (RAM) 1003. In the RAM 1003, various programs and data required for the operation of the device 1000 can also be stored. The computing unit 1001, the ROM 1002, and the RAM 1003 are connected to each other via a bus 1004. An input/output (I/O) interface 1005 is also connected to the bus 1004.

Multiple components in the device 1000 are connected to the I/O interface 1005, including: an input unit 1006, such as a keyboard, a mouse, etc.; an output unit 1007, such as various types of displays, speakers, etc.; a storage unit 1008, such as a magnetic disk, an optical disk, etc.; and a communication unit 1009, such as a network adapter, a modem, a wireless communication transceiver, etc. The communication unit 1009 allows for the device 1000 to exchange information/data with other devices via a computer network, such as the Internet and/or various telecommunication networks.

The computing unit 1001 can be various general-purpose and/or special-purpose processing components with processing and computing capabilities. Some examples of computing unit 1001 include, but are not limited to, a central processing unit (CPU), a graphics processing unit (GPU), various special purpose artificial intelligence (AI) computing chips, various computing units that run machine learning model algorithms, a digital signal processor (DSP), and any appropriate processor, controller, microcontroller, etc. The computing unit 1001 executes the various methods and processing as described in the foregoing, e.g., the road data processing method. For example, in some embodiments, the road data processing method may be implemented as a computer software program which is tangibly contained in a machine-readable medium, such as the storage unit 1008. In some embodiments, part or all of the computer program may be loaded and/or installed on the device 1000 via the ROM 1002 and/or the communication unit 1009. When the computer program is loaded into the RAM 1003 and executed by the computing unit 1001, one or more steps of the road data processing method described in the foregoing can be executed. Alternatively, in other embodiments, the computing unit 1001 may be configured to execute the road data processing method in any other suitable manner (e.g., by means of firmware).

Various implementations of the systems and technologies described herein can be implemented in a digital electronic circuit system, an integrated circuit system, a field programmable gate array (FPGA), an application-specific integrated circuit (ASIC), an application-specific standard product (ASSP), a system-on-chip (SOC), a complex programmable logic device (CPLD), computer hardware, firmware, software, and/or a combination thereof. These various embodiments may include: implementations in one or more computer programs, which are executable by and/or interpreted on a programmable system including at least one programmable processor, the programmable processor may be an application specific or general-purpose programmable processor and can receive data and instructions from a storage system, at least one input apparatus and/or at least one output apparatus, and can transmit the data and instructions to the storage system, the at least one input apparatus, and the at least one output apparatus.

The program codes used to implement the method of this disclosure can be written in any combination of one or more programming languages. These program codes can be provided to a processor or controller of a general-purpose computer, a special-purpose computer, or other programmable data processing devices, so that when the program codes are executed by the processor or controller, functions/operations specified in the flowcharts and/or block diagrams are implemented. The program codes can be executed entirely on a machine, partly on a machine, or as an independent software package that is partly executed on a machine and partly on a remote machine, or entirely on a remote machine or server.

In the context of this disclosure, a machine-readable medium may be a tangible medium, which can contain or store a program for use by, or in combination with, an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the foregoing. More specific examples of the machine-readable storage medium would include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the foregoing.

To provide interaction with the user, the systems and technologies described herein can be implemented on a computer that has: a display apparatus (e.g., a cathode ray tube (CRT) or liquid crystal display (LCD) monitor) for displaying information to the user; and a keyboard and a pointing apparatus (e.g., a mouse or a trackball) through which the user can provide input to the computer. Other kinds of devices may also be used to provide interaction with the user. For example, the feedback provided to the user may be any form of sensory feedback (e.g., a visual feedback, an auditory feedback, or a haptic feedback), and may be in any form (including an acoustic input, a voice input, or a haptic input) to receive input from the user.

The systems and technologies described herein can be implemented in a computing system that includes a back-end component (e.g., as a data server), or a middleware component (e.g., an application server), or a front-end component (e.g., a user computer with a graphical user interface or web browser through which the user can interact with the implementations of the systems and technologies described herein), or any combination of such back-end component, middleware component or front-end component. Various components of the system may be interconnected by digital data communication in any form or via a medium (e.g., a communication network). Examples of a communication network include: a local area network (LAN), a wide area network (WAN) and the Internet.

The computer system may include a client and a server. The client and server are typically remote from each other and interact via a communication network. The client-server relationship is created by computer programs running on corresponding computers having a client-server relationship with each other. The server can be a cloud server, also known as a cloud computing server or a cloud host. It is a mainframe product in the cloud computing service system to solve shortcomings in the traditional physical mainframe and VPS service (Virtual Private Server) associated with difficulties in administrations and low business scalability. The server can also be a server of a distributed system, or a server combined with a blockchain.

It should be understood that the various forms of processes shown above can be reordered, and steps may be add or removed. For example, various steps described in this application can be executed in parallel, in sequence, or in different orders. As long as the desired results of the technical solutions disclosed in this application can be achieved, no limitation is imposed herein.

The foregoing specific implementations do not constitute any limitation on the protection scope of this application. It should be understood by those skilled in the art that various modifications, combinations, sub-combinations and substitutions may be made as needed by design requirements and other factors. Any modification, equivalent substitution, improvement or the like within the spirit and concept of this application shall fall within the protection scope of this application.

What is claimed is:

1. A road data processing method, comprising:
obtaining shape information of a target road and shape information of a reference road;
generating a first segment sequence according to the shape information of the target road;
generating a second segment sequence according to the shape information of the reference road; and
recognizing parallel road segments in the target road and the reference road according to the first segment sequence and the second segment sequence.

2. The method according to claim 1, wherein the shape information of the target road comprises location information of multiple shape points along the target road, and the shape information of the reference road comprises location information of multiple shape points along the reference road, and a sampling point comprises multiple shape points and multiple non-shape points;
the generating the first segment sequence comprises:
sampling along the target road according to the location information of the multiple shape points along the target road to obtain location information of multiple sampling points along the target road; and
constructing the first segment sequence according to the location information of the multiple sampling points along the target road;
and the generating the second segment sequence comprises:
sampling along the reference road according to the location information of the multiple shape points along the reference road to obtain location information of the multiple sampling points along the reference road; and
constructing the second segment sequence according to the location information of the multiple sampling points along the reference road.

3. The method according to claim 2, wherein the constructing the first segment sequence according to the location information of the multiple sampling points along the target road comprises:
forming a segment on the target road out of two adjacent sampling points along the target road to obtain the first segment sequence;
and the constructing the second segment sequence according to the location information of the multiple sampling points along the reference road comprises:
forming a segment on the reference road out of two adjacent sampling points along the reference road to obtain the second segment sequence.

4. The method according to claim 1, wherein the recognizing the parallel road segments in the target road and the reference road according to the first segment sequence and the second segment sequence comprises:
matching the first segment sequence with the second segment sequence to obtain a matching result; and
determining, according to the matching result, parallel road segments of the target road and the reference road if the target road is found leading in the same direction as the reference road.

5. The method according to claim 4, wherein the matching result comprises matching cost values of respective first segments in the first segment sequence with respective second segments in the second segment sequence, and the matching the first segment sequence with the second segment sequence to obtain the matching result comprises:
determining, for the respective first segments in the first segment sequence, angles between the first segments and the respective second segments in the second segment sequence, and determining the matching cost values of the first segments with the respective second segments according to the angles between the first segments and the respective second segments,
wherein the matching cost values of the first segments with the respective second segments reflect a similarity between directions of the first segments and directions of the respective second segments.

6. The method according to claim 5, wherein the determining the angles between the first segments and the respective second segments in the second segment sequence, and the determining the matching cost values of the first segments with the respective second segments according to the angles between the first segments and the respective second segments comprise:
determining, for each of the second segments, an angle between the first segment and the second segment;
obtaining multiple neighbor matching cost values, wherein the neighbor matching cost values comprise a matching cost value of the first segment with a previous segment of the second segment, a matching cost value of a previous segment of the first segment with the second segment, and a matching cost value of a previous segment of the first segment with a previous segment of the second segment; and
determining a matching cost value of the first segment with the second segment according to the respective neighbor matching cost values and the angle between the first segment and the second segment.

7. The method according to claim 6, wherein the determining the matching cost value of the first segment with the second segment according to the respective neighbor matching cost values and the angle between the first segment and the second segment comprises:
obtaining a minimum neighbor matching cost value among the multiple neighbor matching cost values; and
determining the matching cost value of the first segment with the second segment according to a sum of a value of the angle between the first segment and the second segment and the minimum neighbor matching cost value.

8. The method according to claim 5, wherein the determining the parallel road segments of the target road and the reference road comprises:
determining final matching cost values of the respective first segments according to the matching cost values of the respective first segments with the respective second segments;
generating a matching curve graph according to locations of the respective first segments in the first segment sequence and the final matching cost values of the respective first segments; and
determining the parallel road segments according to the matching curve graph.

9. The method according to claim 8, wherein the determining the final matching cost values of the respective first segments according to the matching cost values of the respective first segments with the respective second segments comprise:
determining the matching cost values of the first segments with the second segments in a one-to-one correspondence following an order from back to front in the first segment sequence and an order from back to front in the second segment sequence, to be the final matching cost values of the first segments.

10. The method according to claim 8, wherein the determining the parallel road segments of the target road and the reference road according to the matching curve graph comprises:
determining a first coordinate point and a second coordinate point in the matching curve graph;
obtaining a longitudinal coordinate difference and a horizontal coordinate difference between the first coordinate point and the second coordinate point;
determining a horizontal coordinate range between the first coordinate point and the second coordinate point if a ratio of the longitudinal coordinate difference to the horizontal coordinate difference is less than a preset threshold; and
determining the parallel road segment on the target road according to the horizontal coordinate range.

11. The method according to claim 10, wherein the determining the first coordinate point and the second coordinate point in the matching curve graph comprises:
determining a reference segment in the matching curve graph according to a starting point and an ending point of the matching curve graph;
if the matching curve graph is disposed on both sides of the reference segment, determining a coordinate point on the matching curve graph on one side of the reference segment and farthest from the reference segment to be the first coordinate point, and determining a coordinate point on the matching curve graph on the other side of the reference segment and farthest from the reference segment to be the second coordinate point.

12. The method according to claim 11, wherein the determining the first coordinate point and the second coordinate point in the matching curve graph further comprises:
if the matching curve graph is disposed above the reference segment, determining a coordinate point on the matching curve graph farthest from the reference segment to be the first coordinate point, and determining the ending point of the matching curve graph to be the second coordinate point.

13. The method according to claim 11, wherein the determining the first coordinate point and the second coordinate point in the matching curve graph further comprises:
if the matching curve graph is disposed below the reference segment, determining a coordinate point on the matching curve graph farthest from the reference segment to be the first coordinate point, and determining the starting point of the matching curve graph to be the second coordinate point.

14. The method according to claim 4, wherein the recognizing the parallel road segments in the target road and the reference road further comprises:
obtaining a road length of the target road;
determining a rate of change of the matching result relative to the road length of the target road; and
determining that the target road is leading in the same direction as the reference road if the rate of change satisfies a preset condition.

15. An electronic device, comprising:
at least one processor; and
a memory communicatively connected with the at least one processor, wherein:
the memory stores thereon instructions executable by the at least one processor to enable the at least one processor to:
obtain shape information of a target road and shape information of a reference road;
generate a first segment sequence according to the shape information of the target road;
generate a second segment sequence according to the shape information of the reference road; and
recognize parallel road segments in the target road and the reference road according to the first segment sequence and the second segment sequence.

16. The electronic device according to claim 15, wherein the shape information of the target road comprises location information of multiple shape points along the target road, and the shape information of the reference road comprises location information of multiple shape points along the reference road, and a sampling point comprises multiple shape points and multiple non-shape points;
and the at least one processor is further enabled to:
sample along the target road according to the location information of the multiple shape points along the target road to obtain location information of multiple sampling points along the target road; and
construct the first segment sequence according to the location information of the multiple sampling points along the target road;
sample along the reference road according to the location information of the multiple shape points along the reference road to obtain location information of the multiple sampling points along the reference road; and
construct the second segment sequence according to the location information of the multiple sampling points along the reference road.

17. The electronic device according to claim 16, wherein the at least one processor is further enabled to:
form a segment on the target road out of two adjacent sampling points along the target road to obtain the first segment sequence; and
form a segment on the reference road out of two adjacent sampling points along the reference road to obtain the second segment sequence.

18. The electronic device according to claim 15, wherein the at least one processor is further enabled to:
match the first segment sequence with the second segment sequence to obtain a matching result; and
determine, according to the matching result, parallel road segments of the target road and the reference road if the target road is found leading in the same direction as the reference road.

19. The electronic device according to claim 18, wherein the matching result comprises matching cost values of respective first segments in the first segment sequence with respective second segments in the second segment sequence, and the at least one processor is further enabled to:
determine, for the respective first segments in the first segment sequence, angles between the first segments and the respective second segments in the second segment sequence, and determine the matching cost values of the first segments with the respective second segments according to the angles between the first segments and the respective second segments,
wherein the matching cost values of the first segments with the respective second segments reflect a similarity between directions of the first segments and directions of the respective second segments.

20. A non-transitory computer readable storage medium, storing thereon computer instructions that enable a computer to implement the method according to claim 1.
